(19) United States
(12) Patent Application Publication
(10) Pub. No.: US 2017/0043428 A1
(43) Pub. Date: Feb. 16, 2017

(54) METHOD OF MANUFACTURING COMPOSITE MATERIAL

(71) Applicant: KOREA INSTITUTE OF INDUSTRIAL TECHNOLOGY, Chungcheongnam-do (KR)

(72) Inventors: Kwangjin LEE, Jeollabuk-do (KR); Ram SONG, Jeollabuk-do (KR)

(21) Appl. No.: 15/305,224

(22) PCT Filed: Sep. 1, 2014
(86) PCT No.: PCT/KR2014/008117

§ 371 Date: Oct. 19, 2016

(30) Foreign Application Priority Data
Apr. 24, 2014 (KR) 10-2014-0049626

(51) Int. Cl. B23K 20/12; B23K 20/233

(52) U.S. Cl. CPC B23K 20/1215; B23K 20/128; B23K 20/2333; B23K 2203/10

(57) ABSTRACT

The present invention provides a method of manufacturing composite material, comprising the steps of: coating a thermally conductive composition on a surface portion of a metal material in at least one configuration from among a paste, film, and tape; and friction stirring the metal material, coated with the thermally conductive composition, at least once, and reacting at least a part of the surface portion of the metal material with the thermally conductive composition to form a composite material.

### TECHNICAL FIELD

The present invention relates to a method of manufacturing a composite material, and more particularly, to a method of manufacturing a composite material in which a metal matrix composite material having excellent thermal conductivity is manufactured by using a graphite-based paste in an aluminum alloy base material.

### BACKGROUND ART

Friction stir welding (FSW) is a welding process using heat, which is generated by friction between a tool and a material to be joined through the insertion of the non-consumable tool rotating at a high speed into the material to be joined, and plastic flow of the material to be joined that is softened by the frictional heat, wherein, despite a new welding method that has been only about twenty years since its development by The Welding Institute (TWI) of UK in 1991, since it is a solid state welding process not accompanying melting and solidification processes, mechanical properties of a welded portion are excellent. Thus, the FSW is in the spotlight as a welding process of lightweight metal such as aluminum alloys and magnesium alloys, and its applicability to a high-melting point metallic material, such as carbon steels, high strength steels, stainless steels, and titanium alloys, has been extensively reviewed.

Recently, its utilization possibility has been actively reviewed from different angles, for example, manufacture of metal matrix composites through the modification of a parent material and the dispersion of a carbon material using a friction stir processing (FSP) method to which a principle of the friction stir welding is applied.

However, the surface modification of a material by the friction stirring may only partially change metallurgical characteristics, such as grain structure or redistribution of dispersion phase, in the material having the same chemical composition. In contrast, in a case in which special performance, such as wear resistance or corrosion resistance, is required at a surface of the material, it is difficult to satisfy the required performance by the surface modification only caused by the friction stirring.

Although various coating techniques may be applied to the surface modification in which the special performance is required, it is difficult to obtain mechanical strength at an interface between a member and a coating layer and there is a limitation in that molding or machining of the member after coating is difficult.

### DISCLOSURE OF THE INVENTION

### Technical Problem

The present invention provides a method of manufacturing a metal matrix composite material having less defect and excellent thermal conductivity. However, the problems are exemplary, and the scope of the present invention is not limited by the problems.

### Technical Solution

According to an aspect of the present invention, there is provided a method of manufacturing a composite material including: coating a thermally conductive composition on a surface portion of a metallic material, the thermally conductive composition being in at least one form of a paste, a film, and a tape; and performing a friction stir processing on the metallic material coated with the thermally conductive composition at least once such that at least part of the surface portion of the metallic material reacts with the thermally conductive composition to form a composite material.

A thermally conductive material used as the thermally conductive composition may include at least one of graphite, carbon nanotubes (CNT), and graphene.

The thermally conductive composition may include the thermally conductive material in an amount of 0.1 wt % to 30.0 wt %.

The thermally conductive composition may include at least one of an organic compound, a silicon-based compound, and a lightweight polymer.

The thermally conductive composition may further include hydrocarbons.

The performing a friction stir processing may further include, after a rotating tool is installed on the surface portion of the metallic material coated with the thermally conductive composition, heating the surface portion of the metallic material coated with the thermally conductive composition above a boiling point of the thermally conductive composition such that the thermally conductive composition is uniformly dispersed in the metallic material, by rotating and moving the installed tool.

The metallic material may include aluminum (Al), magnesium (Mg), copper (Cu), or titanium (Ti).

According to another aspect of the present invention, there is provided a method of preparing the composition including: heating the hydrocarbon and the at least one material of the organic compound, the silicon-based compound, or the lightweight polymer in a container; and mixing and stirring the thermally conductive material after the materials are melted.

### Advantageous Effects

According to an embodiment of the present invention, since a friction stir process does not generate toxic gases, is environmentally friendly, and is a solid-state bonding process, processing of an aluminum alloy is possible without deformation, defects are less generated, and a thermally conductive composition having improved productivity and a method of manufacturing a composite material may be provided. However, the scope of the present invention is not limited by these effects.

### BRIEF DESCRIPTION OF THE DRAWINGS

FIG. 1 is a process flowchart schematically illustrating a method of manufacturing a composite material according to an embodiment of the present invention;

FIG. 2 schematically illustrates a friction stir process according to an embodiment of the present invention;

FIG. 3 is a process flowchart schematically illustrating a method of preparing a thermally conductive composition according to an embodiment of the present invention;

FIG. 4 is images of a sample which is analyzed by an optical microscope according to an experimental example of the present invention;

FIGS. 5A to 5H are images of samples for each friction stir process variable which are comparatively analyzed by an optical microscope according to the experimental example of the present invention;

FIGS. 6A to 6E illustrate stress-strain curves of the samples for each friction stir process;

FIG. 7 illustrates the results of X-ray photoelectron spectroscopy (XPS) analysis of the sample illustrated in FIG. 5; and

FIG. 8 is the results of measuring hardness for each position of samples according to friction stir process conditions.

### MODE FOR CARRYING OUT THE INVENTION

Hereinafter, embodiments of the present invention will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Also, sizes of elements in the drawings may be exaggerated for convenience of explanation.

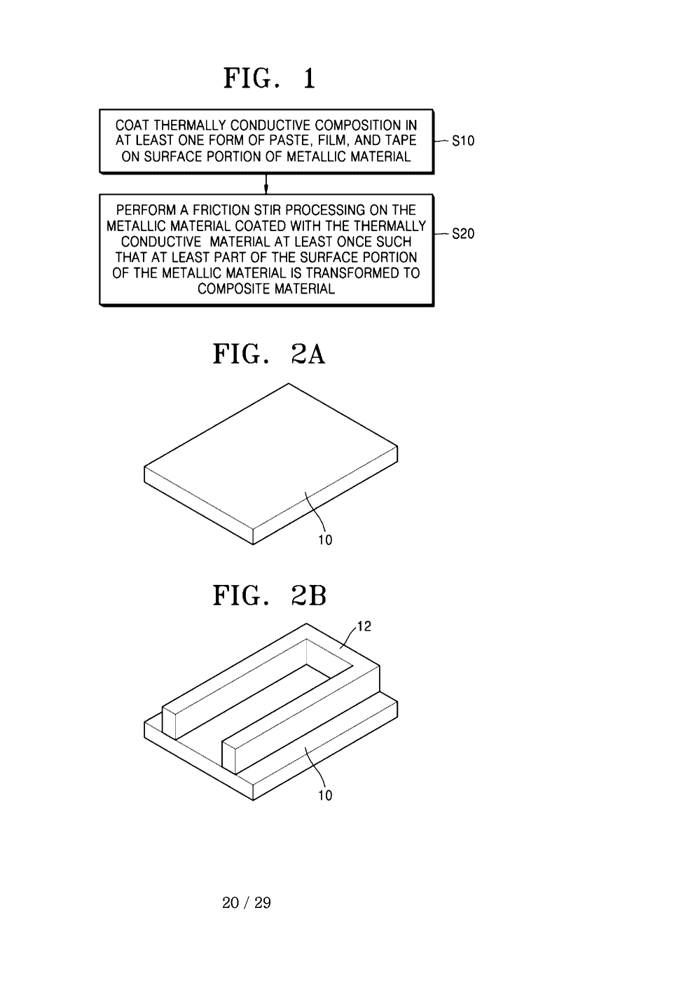

FIG. 1 is a process flowchart schematically illustrating a method of manufacturing a composite material according to an embodiment of the present invention.

Referring to FIG. 1, the method of manufacturing a composite material according to the embodiment of the present invention is as follows. The method may include: coating a thermally conductive composition on a surface portion of a metallic material in at least one form of a paste, a film, and a tape (S10), and friction stirring the metallic material coated with the thermally conductive material at least once to form at least a portion of the surface portion of the metallic material into a composite material (S20).

The metallic material, for example, may include aluminum (Al), magnesium (Mg), copper (Cu), or titanium (Ti). The thermally conductive composition may be coated on the surface portion of the metallic material. The surface portion of the metallic material may not only include a surface of the metallic material, but may also include the inside of the surface. The thermally conductive composition, for example, may be in one form of a paste, a film, and a tape.

In order to improve thermal conductivity, the thermally conductive composition, for example, may include at least one of graphite, carbon nanotubes (CNT), or graphene, as a thermally conductive material. For example, a thermally conductive composition paste prepared as the thermally conductive material is coated on the surface portion of the metallic material, and a composite material may then be formed by moving a rotating tool on the surface portion of the metallic material while heating the surface portion above a boiling point of the thermally conductive composition by installing the rotating tool thereon and rotating the rotating tool.

Detailed descriptions of a friction stir process will be described later with reference to FIG. 2.

FIG. 2 schematically illustrates the friction stir process according to an embodiment of the present invention.

Referring to FIG. 2, drawings schematically illustrating the friction stir process according to the embodiment of the present invention may be seen. First, referring to (a) of FIG. 2, a metallic material 10, for example, aluminum, magnesium, copper, or titanium, is prepared. Referring to (b) of FIG. 2, a member, which may be removed after the friction stir process, may be formed. A tape 12, for example, may be used as the member, and the member may be attached to a surface portion of the metallic material 10 to divide into an area to be subjected to the friction stir process and an area not to be subjected to the friction stir process. Referring to (c) of FIG. 2, a thermally conductive composition 14 may be coated on the surface portion of the metallic material 10 in the area to be subjected to the friction stir process. A reinforcement in the form of a tape or film, in addition to the form of a paste, for example, may be used in the thermally conductive composition 14. A coating method of the thermally conductive composition 14 may be selectively used according to a type of the metallic material and a type of the thermally conductive material used, process environment, and required properties.

Also, referring to (d) of FIG. 2, a rotating tool 16 is installed on the surface portion of the metallic material 10 which is coated with the thermally conductive composition 14. Thereafter, frictional heat may be generated by rotating the tool 16 at a high speed. The frictional heat may heat the surface portion of the metallic material 10 above a boiling point of the thermally conductive composition to melt the metallic material 10. While the thermally conductive composition 14 coated on the surface portion of the metallic material 10 is uniformly dispersed in the molten metallic material 10, at least a portion of the surface portion of the metallic material 10 is formed into a composite material which has different chemical or physical properties when compared with a base parent material.

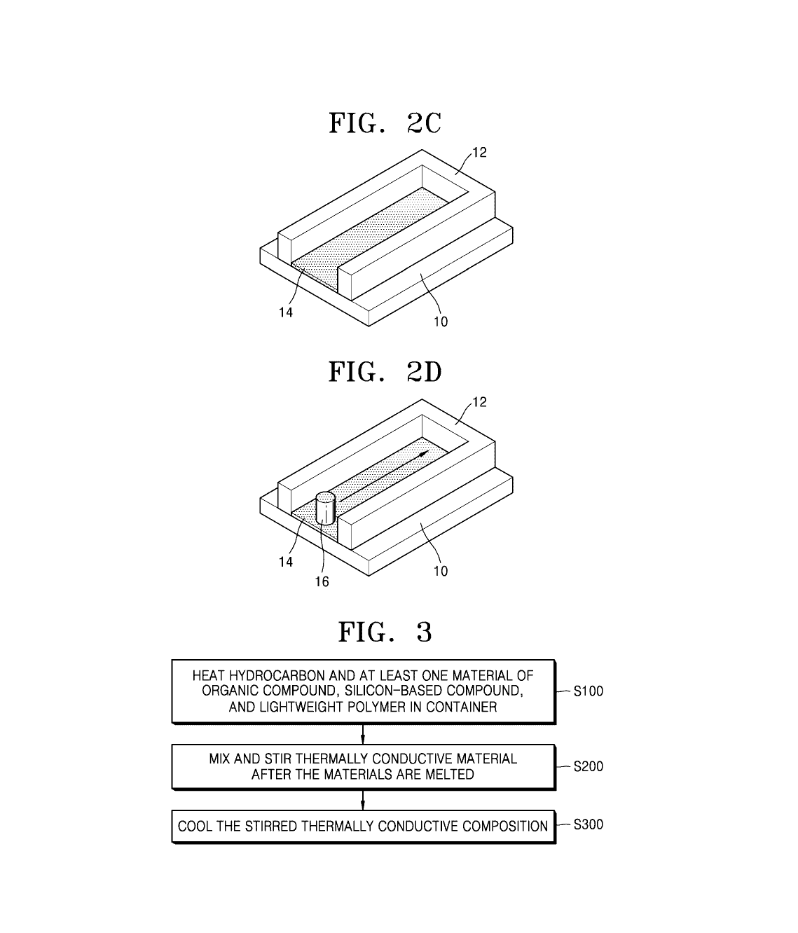

FIG. 3 is a process flowchart schematically illustrating a method of preparing a thermally conductive composition according to an embodiment of the present invention.

Referring to FIG. 3, the method of preparing a thermally conductive composition may include: putting hydrocarbon and at least one material of an organic compound, a silicon-based compound, or a lightweight polymer in a container and heating the container (S100), mixing and stirring a thermally conductive material after the materials are melted (S200), and cooling the stirred thermally conductive composition (S300).

Specifically, the thermally conductive composition, for example, may include at least one selected from the group consisting of an organic compound, a silicon oil, and a lightweight polymer. The organic compound, for example, may be selected from organic compounds having a functional group such as ether, alcohol, amine, alkyl halide, a carboxyl group, an aldehyde group, a ketone group, and an ester group.

Furthermore, in addition to the compound included in the thermally conductive composition, the thermally conductive composition may further include chemically stable hydrocarbon. For example, at least one of olefinic hydrocarbon, naphthenic hydrocarbon, or aromatic hydrocarbon having a benzene nucleus may be used as the hydrocarbon.

The hydrocarbon and the at least one material of the above-described organic compound, silicon-based compound, or lightweight polymer may be put in a container and may be heated with a hot plate. After the materials are melted, at least one selected from graphite, carbon nanotubes (CNT), and graphene may be added to the molten materials and stirring may be performed. An amount added to the molten materials may be in a range of about 0.1 wt % to about 30.0 wt % and the stirring may be performed. Since viscosity may be changed according to the amount of the thermally conductive material during the friction stir process, dispersion or alloying may not be performed to obtain a uniform composition ratio. Thus, the amount of the thermally conductive material may be limited.

Finally, when the heating of the composition after the completion of the stirring is terminated and cooling is performed, the preparation of the thermally conductive composition is completed. The thermally conductive composition may be processed to prepare one form of a paste, a film, and a tape. The prepared thermally conductive composition may be selectively used according to the type of the metallic material and the type of the thermally conductive material used in the friction stir process, process environment, and required properties.

Also, in order to facilitate the evaporation of the thermally conductive composition during the friction stir process, the thermally conductive composition may include at least one non-polar material (material having a dielectric constant of about 15 or less and a dipole moment of about 2.0 or less) in which a boiling point is about 773K or less, a melting point is in a range of about 323K to about 473K, and a viscosity at room temperature is in a range of about 100 CPS to about 10,000 CPS.

Hereinafter, an experimental example, to which the above-described technical ideas are applied, will be described to allow for a clearer understanding of the present invention. However, the following experimental example is merely provided to allow for a clearer understanding of the present invention, rather than to limit the scope thereof.

### EXPERIMENTAL EXAMPLE

A 2.0 mm thick plate of aluminum alloy AA1050-0 was used and a graphite paste was coated on a surface portion of the aluminum alloy. A rotating tool was installed on the aluminum alloy plate coated with the graphite paste and was then rotated at a high speed to prepare a composite material sample having excellent thermal conductivity through a reaction between the graphite and the aluminum alloy. The aluminum alloy material and friction stir process conditions used in the experimental example of the present invention are presented in Tables 1 to 4.

The following Table 1 illustrates a composition of the aluminum alloy, and Table 2 illustrates information of the graphite paste.

TABLE 1

| | Alloying element (wt %) | | | | | | | | |
|---|---|---|---|---|---|---|---|---|---|
| Alloy | Si | Fe | Cu | Mn | Mg | Cr | Zn | Ti | Al |
| AA1050-O | 0.16 | 0.27 | 0.03 | — | — | — | — | 0.02 | Bar. |

TABLE 2

| | | | | Average | Apparent |
|---|---|---|---|---|---|
| | Solid carbon | | Volatile | particle | density |
| Product code | (%) | Ash (%) | matter (%) | size (μm) | (g/cm³) |
| CSP-E | >98.0 | <1.0 | <1.0 | 8 | 0.13 |

Table 3 illustrates information of the tool used when the friction stir process was performed, and Table 4 illustrates the friction stir process conditions.

TABLE 3
Tool geometry

| Shoulder diameter | Probe diameter | Probe length | |
|---|---|---|---|
| (mm) | (mm) | (mm) | Material |
| 10 | 5 | 1.8 | SKD61 |

TABLE 4

| Rotation speed | Traveling speed | Tool plunge depth | |
|---|---|---|---|
| (RPM) | (mm/min) | (mm) | Reinforcement |
| 1,800 | 150 | 1.8 | Graphite Paste |
| | | | (10%, 20%) |

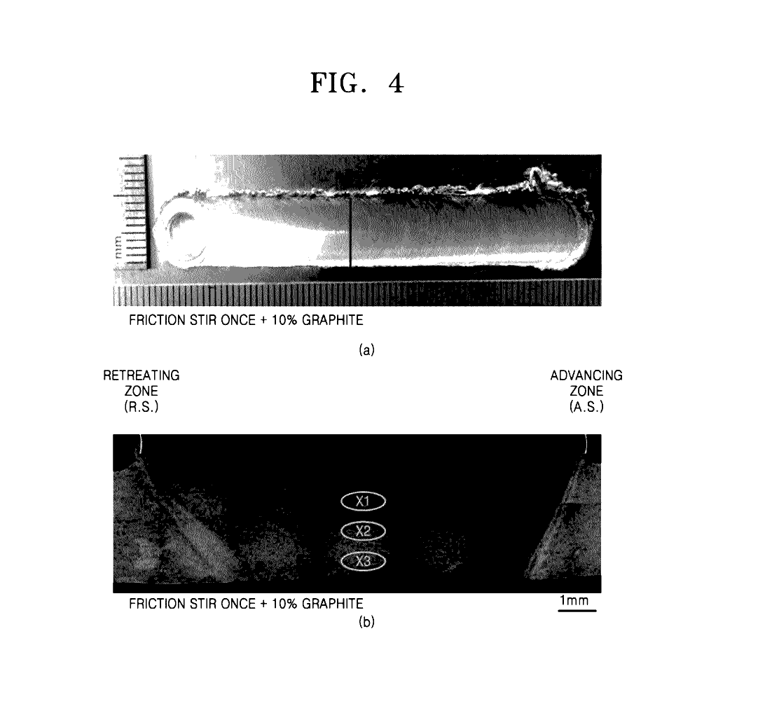

Samples prepared under the process conditions illustrated in Table 4 were analyzed using an optical microscope, a Vickers hardness tester, a tensile tester, an X-ray photoelectron spectrometer (XPS), and a thermal conductivity analyzer. The results thereof will be described later with reference to FIGS. 4 to 8 and each table.

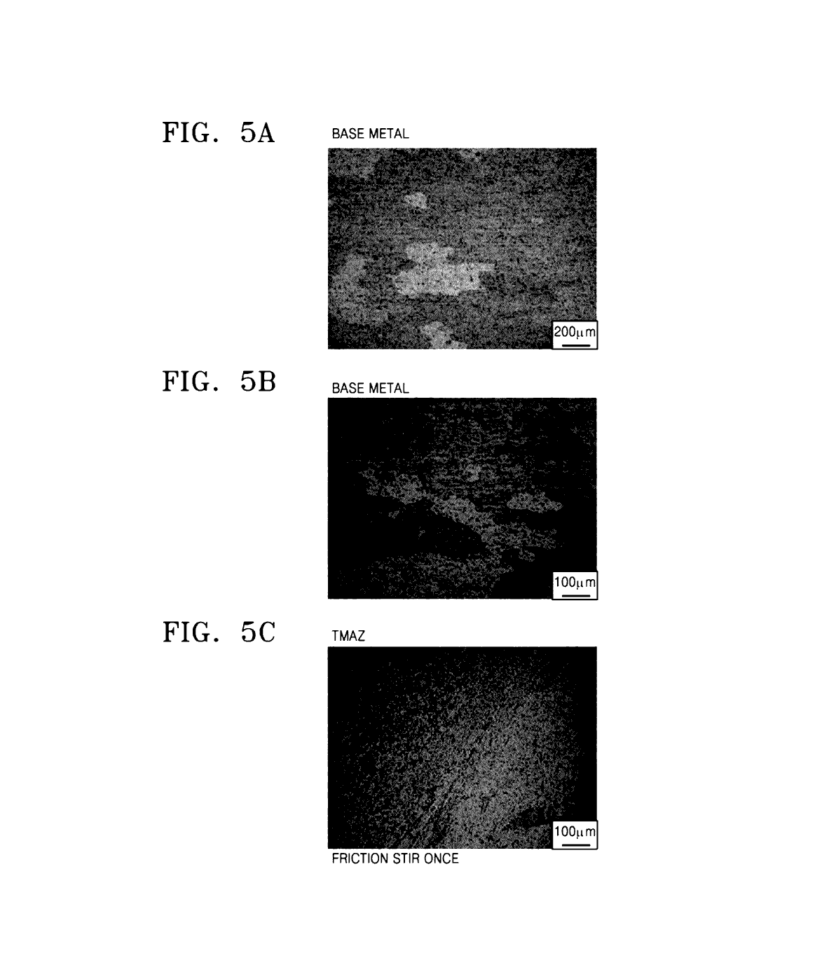

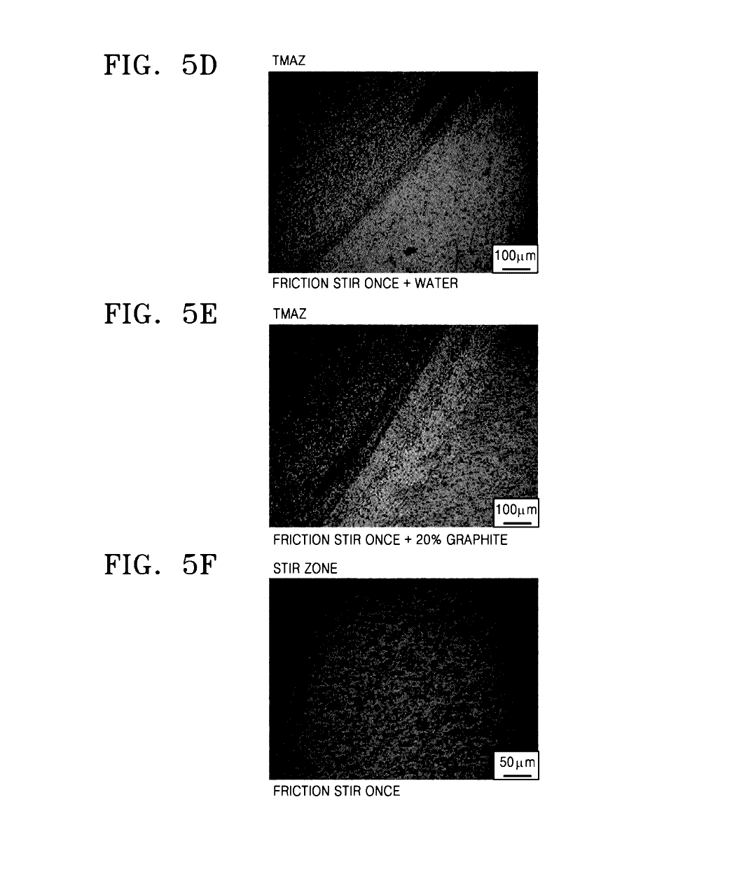

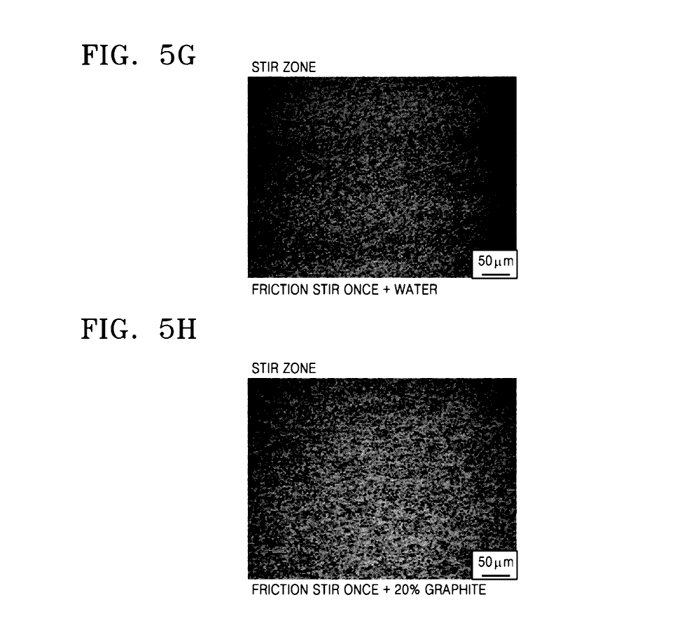

FIG. 4 is images of the sample which was analyzed by the optical microscope according to the experimental example of the present invention, and FIGS. 5A to 5H are images of the samples for each friction stir process variable which were comparatively analyzed by the optical microscope according to the experimental example of the present invention.

First, referring to FIG. 4, (a) of FIG. 4 is an image of the top of the sample prepared by the friction stir process using a 10% graphite paste which was analyzed by the optical microscope, and (b) of FIG. 4 is a cross-sectional view taken along line CC″ of the sample illustrated in (a) of FIG. 4.

FIGS. 5A and 5B are images of the surface of the aluminum alloy which were observed with magnifications, FIGS. 5C, 5D, and 5E are images of thermo-mechanically affected zones (TMAZ) (A.S.) of the aluminum alloy, and FIGS. 5G and 5H are images of stir zones of the aluminum alloy.

Referring to FIGS. 4 and 5A to 5H, in the surface and cross-section of the sample, graphite particles were not clearly distinguished and observed, and any defect was not observed but only a trace due to the performance of the friction stir process. Also, it may be observed that particles of the aluminum alloy were very finely formed by the friction stir process.

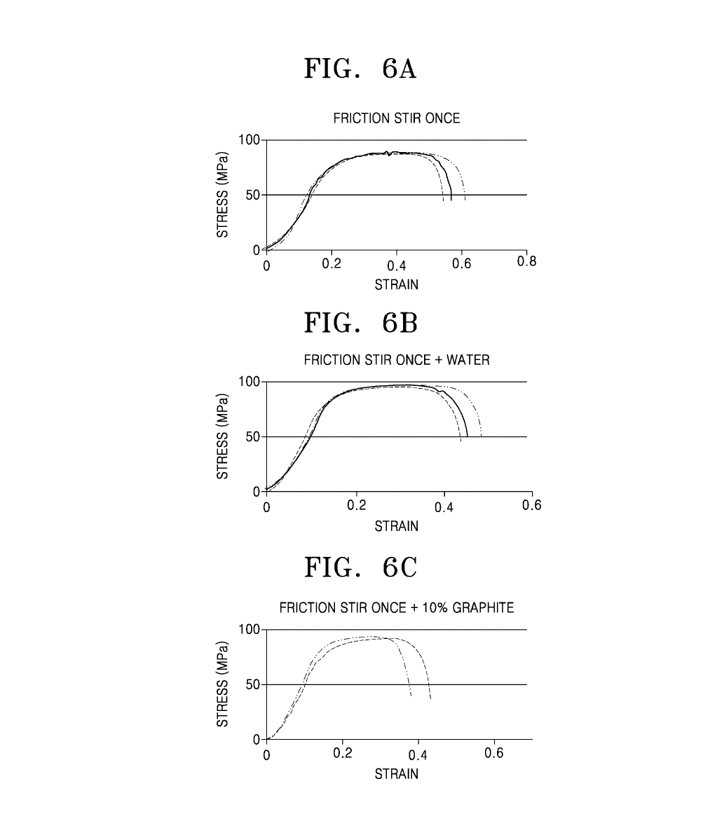

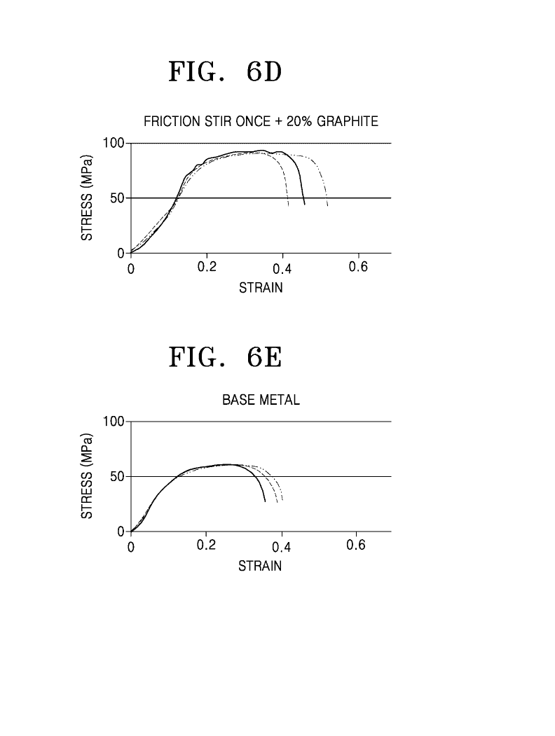

FIGS. 6A to 6E illustrate stress-strain curves of the samples for each friction stir process.

Referring to FIGS. 6A to 6E, it may be confirmed that maximum tensile strength and total elongation of the stir zones of the samples for each friction stir process illustrated in FIGS. 6A to 6D were improved in comparison to those of the base parent material illustrated in FIG. 6E.

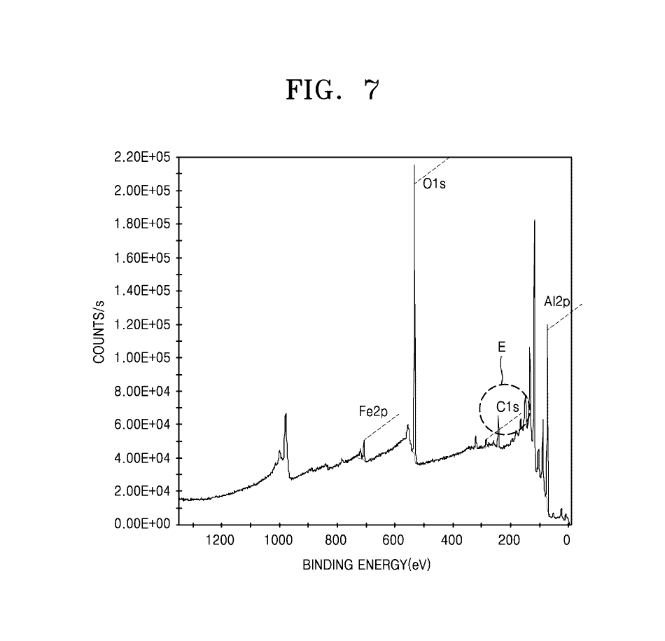

FIG. 7 illustrates the results of XPS analysis of the sample illustrated in FIG. 5.

Table 5 illustrates XPS data of the sample illustrated in FIG. 7.

TABLE 5

| | | Chemical shift | Atomic % |
|---|---|---|---|
| Sample | Peak position (eV) | (eV) | concentration |
| Reference (BM) | 284.5 | — | — |
| X1 | 283.48 | −1.02 | 6.96 |
| X2 | 283.27 | −1.23 | 6.33 |
| X3 | 283.25 | −1.25 | 4.66 |

Referring to area E marked in dotted line in FIG. 7, it may be confirmed that a carbon component was present in the aluminum alloy after the friction stir process. Thus, it may be understood that graphite was dispersed and reacted with the aluminum alloy while the friction stir process was performed.

Also, referring to FIG. 4 and Table 5, in a case in which compositional analysis was sequentially performed on X1, X2, and X3 areas illustrated in (b) of FIG. 4 based on the aluminum alloy parent material, it may be confirmed that an atomic weight ratio of carbon in the upper portion X1 of the aluminum alloy subjected to the friction stir process was higher than an atomic weight ratio of carbon in the lower portion X3 of the aluminum alloy. Thus, it may be understood that, since the friction stir process was performed on the surface portion of the aluminum alloy, the reaction range was gradually increased from the upper portion of the aluminum alloy to the lower portion thereof.

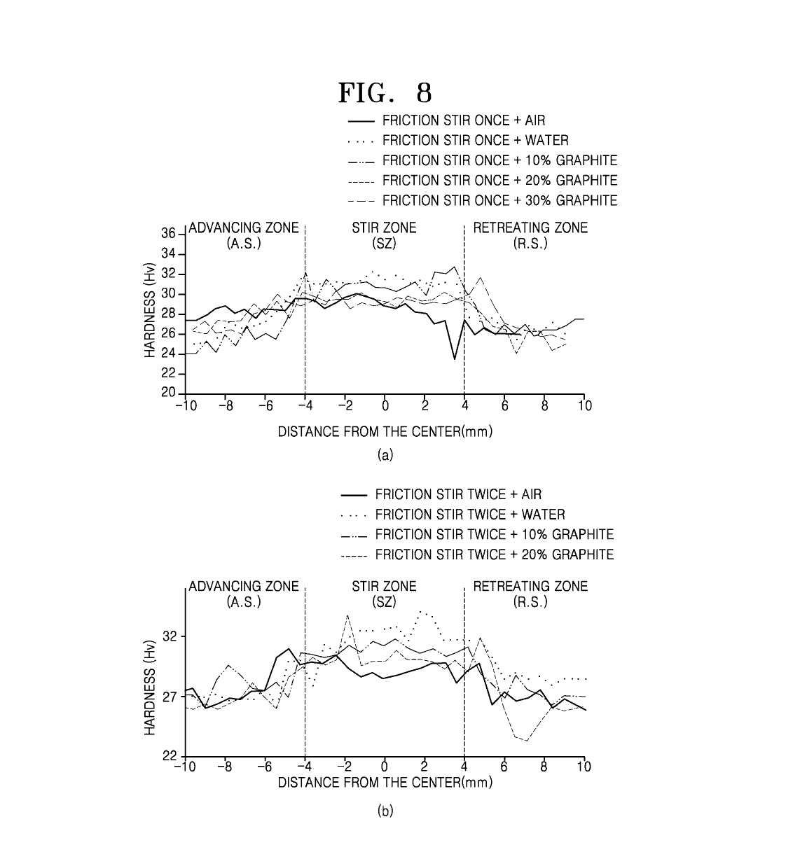

FIG. 8 is the results of measuring hardness for each position of the samples according to friction stir process conditions.

(a) of FIG. 8 is a graph in which hardness values were measured after performing the friction stir process once. While the friction stir process proceeded, there was no significant difference in the hardness value for each friction stir process, but it may be confirmed that the value obtained when the friction stir process was performed in an air atmosphere was slightly low.

With respect to (b) of FIG. 8, results similar to those of (a) of FIG. 8 were obtained, and it may be confirmed that a value obtained when the friction stir process was performed in an air atmosphere was slightly low in a center portion subjected to the friction stir process, i.e., the stir zone.

Referring to the above-described results of the optical microscopy analysis, dynamic recrystallization was performed between the surface portion of the aluminum alloy and the graphite particles, and accordingly, a structure of the aluminum was improved. Thus, it may be confirmed that the hardness of the center portion of the aluminum alloy subjected to the friction stir process, i.e., the stir zone, was more increased than those of other areas.

Finally, thermal conductivity data of the sample prepared according to the experimental example of the present invention is illustrated in Table 6.

TABLE 6

| Sample conditions | | Thermal conductivity (W/(m * K)) |
|---|---|---|
| BM | AA1050-O | 20.226 |
| 1 pass | Friction stir | 210.52 |
| | Friction stir + water | 212.536 |
| | Friction stir + | 213.963 |
| | 10% graphite | |
| | Friction stir + | 215.563 |
| | 20% graphite | |
| 2 pass | Friction stir | 222.142 |
| | Friction stir + water | 233.920 |
| | Friction stir + | 211.324 |
| | 10% graphite | |
| | Friction stir + | 236.513 |
| | 20% graphite | |

Referring to Table 6, it may be confirmed that thermal conductivity of the sample, in which 20% graphite was used and the friction stir process was performed two consecutive times, was improved by about 16% in comparison to that of the base metallic material.

As described above, in the present invention, a metal matrix composite material having improved thermal conductivity was manufactured by using the friction stir process, as a composite material manufacturing technique, and adding the graphite component, as a reinforcement, to the aluminum alloy matrix. In order to find optimal process conditions, the rotation speed and traveling speed of the tool were controlled, and consequently, effects may occur in which the microstructure, mechanical properties, and thermal conductivity were improved.

Although the present invention has been described with reference to the embodiment illustrated in the accompanying drawings, it is merely illustrative, and those skilled in the art will understand that various modifications and equivalent other embodiments of the present invention are possible. Thus, the true technical protective scope of the present invention should be determined by the technical spirit of the appended claims.

1. A method of manufacturing a composite material, the method comprising:
coating a thermally conductive composition on a surface portion of a metallic material, the thermally conductive composition being in at least one form of a paste, a film, and a tape; and
performing a friction stir processing on the metallic material coated with the thermally conductive composition at least once such that at least part of the surface portion of the metallic material reacts with the thermally conductive composition to form a composite material.

2. The method of claim 1, wherein a thermally conductive material used as the thermally conductive composition comprises at least one of graphite, carbon nanotubes (CNT), and graphene.

3. The method of claim 2, wherein the thermally conductive composition comprises the thermally conductive material in an amount of 0.1 wt % to 30.0 wt %.

4. The method of claim 1, wherein the thermally conductive composition comprises at least one of an organic compound, a silicon-based compound, and a lightweight polymer.

5. The method of claim 1, wherein the thermally conductive composition further comprises hydrocarbons.

6. The method of claim 1, wherein, the performing a friction stir processing further comprises:
after a rotating tool is installed on the surface portion of the metallic material coated with the thermally conductive composition, heating the surface portion of the metallic material coated with the thermally conductive composition above a boiling point of the thermally conductive composition such that the thermally conductive composition is uniformly dispersed in the metallic material, by rotating and moving the installed tool.

7. The method of claim 1, wherein the metallic material comprises aluminum (Al), magnesium (Mg), copper (Cu), or titanium (Ti).

8. The method according to claim 1, wherein the thermally conductive composition is prepared by a method comprising:
heating the hydrocarbon and the at least one material of the organic compound, the silicon-based compound, or the lightweight polymer in a container; and
mixing and stirring the thermally conductive material after the materials are melted.

9. The method according to claim 2, wherein the thermally conductive composition is prepared by a method comprising:
heating the hydrocarbon and the at least one material of the organic compound, the silicon-based compound, or the lightweight polymer in a container; and
mixing and stirring the thermally conductive material after the materials are melted.

10. The method according to claim 3, wherein the thermally conductive composition is prepared by a method comprising:
heating the hydrocarbon and the at least one material of the organic compound, the silicon-based compound, or the lightweight polymer in a container; and
mixing and stirring the thermally conductive material after the materials are melted.

11. The method according to claim 4, wherein the thermally conductive composition is prepared by a method comprising:
heating the hydrocarbon and the at least one material of the organic compound, the silicon-based compound, or the lightweight polymer in a container; and
mixing and stirring the thermally conductive material after the materials are melted.

12. The method according to claim 5, wherein the thermally conductive composition is prepared by a method comprising:
heating the hydrocarbon and the at least one material of the organic compound, the silicon-based compound, or the lightweight polymer in a container; and
mixing and stirring the thermally conductive material after the materials are melted.
